(19) United States
(12) Patent Application Publication
(10) Pub. No.: US 2008/0276421 A1
(43) Pub. Date: Nov. 13, 2008

(54) Protective Cover for Hinge in a Door Assembly

(76) Inventor: David Vanderpan, Lincoln, CA (US)

Correspondence Address: BULLIVANT HOUSER BAILEY PC, 1415 L STREET, SUITE 1000, SACRAMENTO, CA, 95814, US

(21) Appl. No.: 12/119,444

(22) Filed: May 12, 2008

Related U.S. Application Data
(60) Provisional application No. 60/917,286, filed on May 10, 2007.

(51) Int. Cl. E05D 11/00

(52) U.S. Cl. 16/250

(57) ABSTRACT

The invention provides a protective cover for application to a longitudinal door hinge comprising a cylindrical bore and two extensions for attaching to a door and door jamb, respectively, the protective cover comprising a cylindrical portion having an inner diameter dimensioned to closely fit the outer surface of the hinge bore, the cylindrical portion having a longitudinal opening at least as long as the hinge bore and narrower in width than the width of the hinge bore, where the protective cover is produced of molded flexible material, and where the cylindrical portion can be flexibly manipulated to expand the size of the longitudinal opening to fit over the bore for removable attachment of the protective cover to the hinge.

### CROSS REFERENCE TO RELATED APPLICATIONS

This application claims priority to, and the benefit of, U.S. Provisional Application No. 60/917,286, filed May 10, 2007 and entitled “Protective Cover for Hinge in a Door Assembly”, which is hereby incorporated by reference in its entirety.

### BACKGROUND OF THE INVENTION

1. Field of the Invention

This invention describes a simple and inexpensive cover for protecting door surfaces and hinges in the transhipped of pre-assembled doors.

2. Description of Related Art

The majority of doors for new homes or other construction projects are now sold as pre-hung door jamb assemblies. In such an assembly, the door is already hung in the jamb assembly when it is purchased, either by a builder or a construction firm. This is accomplished by attaching the door to one side of the jamb assembly by a hinge or hinges, or other equivalent securing means. The other side of the door is usually provided with a lockset and knob opening. The jamb member positioned immediately adjacent to the lockset and knob opening side is fixed with a latch or striker plate opening so that the door can be securely shut after it has been installed.

When a builder purchases a pre-hung door jamb assembly, the door will typically be shipped inside of the door jamb. That is, the door will be “closed” as opposed to “open” in the jamb. To keep the door closed during shipping, the manufacturer may directly fasten the door and the jamb together on the side opposite the hinges. Alternatively, the manufacturer may space the jamb from the door by a plurality of shipping stabilizers. These stabilizers are often thin pieces of wood, paper or cardboard. The stabilizers are secured and held in place in between the door and jamb either by nail or by adhesive. The entire assembly may then be strapped with a cellophane material or the like. For commercial metal pre-hung doors, L-shaped stabilizing brackets may be bolted into the edge of the door and the front of the jamb. Stanley Tools uses these types of L-shaped brackets.

In most cases, when the pre-hung door jamb assembly arrives at the installation site, the builder frees the jamb member opposite the hinges by removing any nails or strapping that restricts the swinging of the door. Generally, the builder removes all of the pieces attached to the door jamb assembly during shipping, save the hinges. In this manner, the door may swing inside the jamb at the hinges, thus facilitating the installation of the assembly into the door frame.

A difficulty in this approach is the various elements pre-attached to the assembly which may be damaged in transhipment. Further, pieces, such as the hinges, which stick out from the assembly are both more prone to damage, and more likely to damage an adjacent assembly when door assemblies are stacked together.

Accordingly, it is desirable to provide a simple, and inexpensive device that will aid in protect the hinge. Additionally, it is desirable to provide a device which will protect the assemblies from damage during shipping. It is to these ends that the present invention is directed.

U.S. Pat. Nos. 6,637,073 and 6,557,210, to Kincaid teach a cover for temporarily covering a hinge, the hinge having a first portion for mounting on a fixed surface and a second portion for mounting on a door, the second portion hingedly attached to the first portion, the hinge having a first position wherein the first and second portions are perpendicular to one another, and a second position wherein the first and second portions are parallel to one another. The hinge cover includes a first member having a raised central channel, first left and right flanges, and a first vertical flange for resiliently engaging at least one vertical surface of the first hinge portion. A second member includes a raised channel, second left and right flanges, and a second vertical flange for resiliently engaging at least one vertical surface of the second hinge portion, the second body portion raised channel adapted for receiving a portion of the first member raised central channel.

U.S. Pat. No. 6,854,162, to Emerson, et al., discloses a door hinge cover as a temporary mask that completely protects a door hinge during painting, is reusable, can be used on a hanging door easily and allows movement of the door during the painting process. The device includes two portions used in combination; one portion for protecting the hinge plates and a portion for protecting the hinge cylinder. The hinge plate protector is made from a flexible material and removably attaches to the hinge plates using a magnetic material. The hinge cylinder protector is also made from a flexible material and removably attaches to the hinge cylinder using a magnetic material. The two portions used in combination completely protect the door hinge during painting.

U.S. Pat. No. 5,063,638, to Howard, et al., provides a hinge assembly that includes a cover. A jamb cover of the assembly is adjustably mounted relative to a wall jamb. An adjuster sub-assembly is mounted within the jamb cover. The adjuster sub-assembly includes a bracket with a nut mounted thereon. An adjuster screw, the head of which is secured in a keyhole slot of the wall jamb, threadably engages the nut. A leaf spring is attached to the bracket, and a hinge member for the door extends through the jamb cover and contacts the leaf spring. The hinge is thus concealed from view.

None of these prior approaches have been able to provide a simple protector for a hinge that is temporary, yet can be stably applied and easily removed from hinges of the transhipped door.

### SUMMARY OF THE INVENTION

In accordance with this invention, protective cover clips are provided wherein each of the clips comprises a plastic or substantially similar material that is shaped in such a way as to attach to the hinge of a door, or door assembly, to protect the hinge, as well as the door surface of an adjacent door.

To accomplish these functions, the invention provides a protective cover for application to a longitudinal door hinge of the kind comprising a cylindrical bore and two extensions for attaching to a door and door jamb, respectively

The protective cover generally comprises a cylindrical portion having an inner diameter dimensioned to closely fit the outer surface of the hinge bore, the cylindrical portion having a longitudinal opening at least as long as the hinge bore and narrower in width than the width of the hinge bore, where the protective cover is produced of molded flexible material, and where the cylindrical portion can be flexibly manipulated to expand the size of the longitudinal opening to fit over the bore for removable attachment of the protective cover to the hinge.

The invention also contemplates a protective cover where the molded flexible material is plastic. The plastic can be of any suitable type, such as HDPE or LDPE.

The invention additionally contemplates such a protective cover that further comprises a flap portion extending from the cylindrical portion, where when the cylindrical portion is attached to the hinge, the extension lays over the jamb of a pre-hung assembly. In one such aspect of the protective cover the flap portion is substantially flat.

The invention further contemplates a protective cover where the flap portion is sized to overlay screw tips associated with the attachment of the hinge to the jamb. Preferably, the protective cover where the flap portion is integrally formed with the cover portion. The flap portion is also preferably sized to allow penetration of staples to further secure the protective cover to the jamb.

In another aspect, the protective cover of the invention may comprise a raised portion connected to the protective cover for providing spacing between doors. The protective cover can also comprise a ledge portion for positioning the protective cover with respect to the jamb.

The protective cover of the invention also contemplates an expanded notched region at the respective ends of the longitudinal opening, for ease of application to a hinge. In a further embodiment of the protective, the cylindrical portion is at least about 2 inches in length, though equally preferred protective covers are of at least about 3 inches in length, and even at least about 4 inches in length.

These and other features and advantages of this invention are described in, or are apparent from, the following detailed description of various exemplary embodiments of the apparatus and methods according to this invention.

### BRIEF DESCRIPTION OF THE DRAWINGS

FIG. 1 shows a top view of the protective cover of the invention having a cylindrical bore portion with notched regions and raised ridges.

FIG. 2 is a plan view of the embodiment of FIG. 1.

FIG. 3 is an end view of the protective cover.

FIG. 4 shows view taken along line A-A of FIG. 1.

FIG. 5 shows a side view of an alternative embodiment of the protective cover of the invention, having a flap portion and a raised portion, where the flexible flap is used in applications where hinge screw point protection is required.

FIG. 6 is a bottom view of the cover shown in FIG. 5.

FIG. 7 shows a side view of a variation on the embodiment having flap and raised portions.

FIG. 8 shows a perspective view of the protective cover depicted in FIG. 7.

FIG. 9 shows a front perspective view of another variation on the protective cover having a flap extension and a ledge portion.

FIG. 10 shows bottom perspective view of the protective cover of FIG. 9.

FIG. 11 shows top view of the protective cover of FIG. 9.

FIG. 12 if a front plan view of the protective cover of FIG. 9.

FIG. 13 is a side view of the protective cover of FIG. 9.

FIG. 14 shows back view of the protective cover of FIG. 9.

### DETAILED DESCRIPTION OF THE INVENTION

The products and methods of the present invention are protective covers useful for applying to hinges of the type comprising a longitudinal and cylindrical bore and two extensions for attaching to a door and a door jamb, respectively.

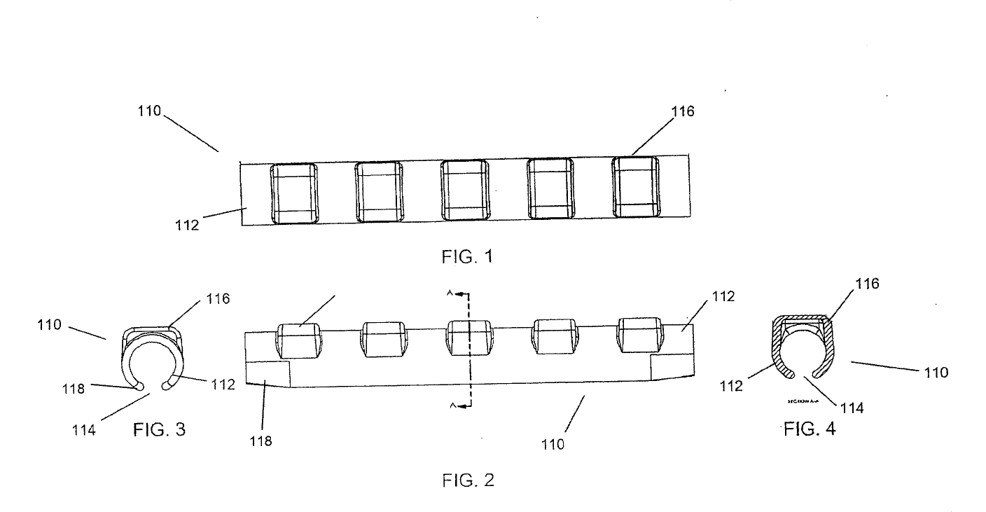

FIGS. 1 through 4 show the simplest aspect of the protective cover 110, with a cylindrical bore portion with notched regions. The protective cover 110 is produced of a plastic or substantially similar material that is shaped in such a way as to attach to the hinge of a door, or door assembly, to protect the hinge, as well as the door surface of an adjacent door.

The protective cover 110 generally comprises a cylindrical portion 112 that snaps over hinge of an assembled door. Cylindrical portion 112 has an inner diameter dimensioned to closely fit the outer surface of the hinge bore, the cylindrical portion 112 having a longitudinal opening 114 at least as long as the hinge bore and narrower in width than the width of the hinge bore. Where the protective cover 110 is produced of molded flexible material, the cylindrical portion 112 can be flexibly manipulated to expand the size of the longitudinal opening 114 to fit over the bore for removable attachment of the protective cover 110 to the hinge. Thus invention contemplates a protective cover 110 where the molded flexible material is plastic. The plastic can be of any suitable type, such as HDPE or LDPE. The part 110 can be made of any injection moldable material or blend of materials in order to achieve the proper trade-off of strength, cost, flexibility and rigidity.

Cylindrical portion 112 provides a covering for the hinge of a door in shipment. Fins, or ridges 116 built into the cylindrical portion 112 provide additional cushion and spacing between the hinges of stacked doors. Ridges 116 also provide added strength as well as eliminate a potential catch point area for another door to hang up on and to roll the part off the hinge. The design thus provides hinge protector 110 that gives separation between doors, not just a cover for the hinge. Door separation is an important aspect of the protection provided by the part.

The protective cover of the invention also contemplates an expanded notched region 118 at the respective ends of the longitudinal opening 114, for ease of application to a hinge.

The protective part 110 can be produced to fit inside or exterior doors and any jamb thickness. The part 110 can be supplied in any length, usually dependent on a trade-off between protection and cost. The cylindrical portion is at least about 2 inches in length, though equally preferred protective covers are of at least about 3 inches in length, and even at least about 4 inches in length.

The protective part 110 can also be placed on the head jam, or the “hingeless side” of the jamb, and used as a door separator. For this application 3 or 4 staples would typically be used to secure it to the jamb.

Among other advantages to the protective part 110 are improving the lead in available to provide ease of installation.

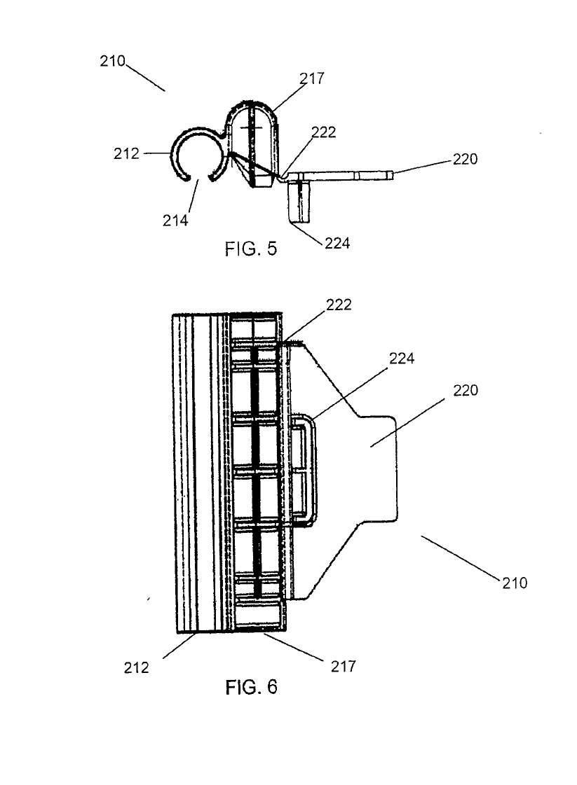

FIGS. 5 and 6 show an alternative protective cover, designated 210, that further comprises a flap portion, or extension 220, extending from the cylindrical portion 212. For protective cover 210, features that are the same or similar to those found in the first version of the protector 110 are given similar numerals, only having the same last two digits succeeding the number 2, hence the cylindrical portion 212, rather than 112.

In reference to FIGS. 5 and 6, while cylindrical portion 212 is attached to a door hinge, the extension 220 lays over the jamb of a pre-hung door assembly. In one such aspect of the protective cover 210 the flap portion 212 is substantially flat. In application, the cylindrical portion 212 of protective cover 210 snaps over the hinge and is secured with one staple through the extension 220. The protective part 210 also offers protection of adjacent doors with the raised pad area 217 that is located adjacent the cylindrical portion 212, rather than built onto the cylindrical portion 212, as was the case for the protective part 110 shown in FIGS. 1 through 4. The raised portion 217 provides additional protection for the hinge by providing a cushion between doors.

A thinned plastic region 222 allows the extension 220 to be easily flexed and moved into position over a door jamb during assembly. When the extension 220 in position over the jamb, a jamb ledge/support 224 stabilizes the part on the door by offering positioning and additional support.

The extension 220 also provides screw point protection, i.e., the protective cover 210 provides protection against screws protruding through the jam. The protective cover 210 thus provides protection for the hinge and a cushion between doors—interior or entry, spacing sills and a guard against hinge screw point injury. The flap extension 220 is also preferably sized to allow penetration of staples to further secure the protective cover to the jamb. Most preferably, the protective cover where the extension 220 is integrally formed with the cover portion of suitable plastic material.

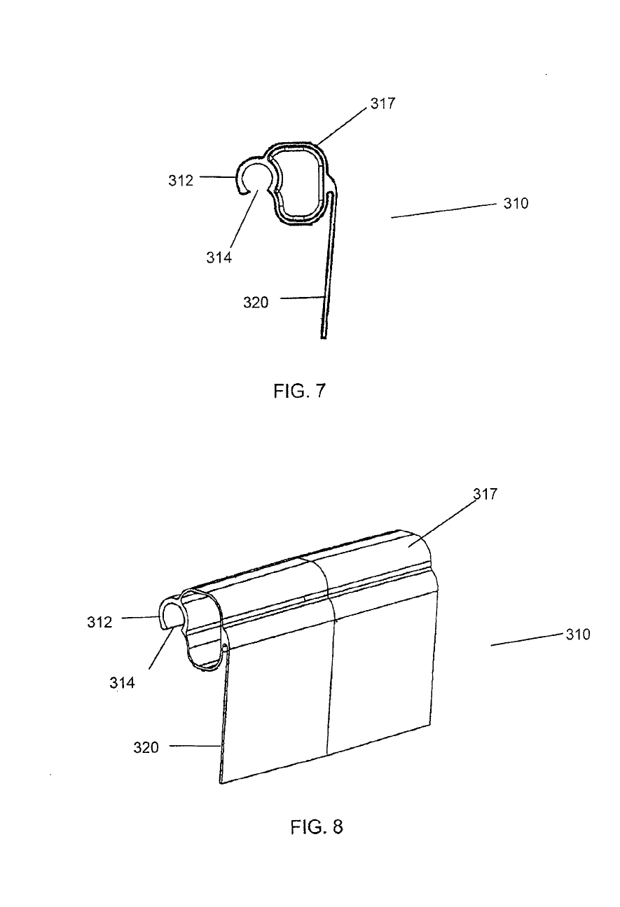

In reference the version of the protective cover 310 shown in FIGS. 7 and 8, the extension 320 is produced in a ready position to cover the jamb. In this aspect, the protective cover 310 not only firmly snaps on to the hinge, thereby providing hinge protection, but is also retrofitted with a more substantial raised portion 317 as an added safeguard to the door face and head. For protective cover 310, features that are similar to those found in the first version of the protector 110 are given similar numerals, only having the same last two digits succeeding the number 3.

In order to provide such a cushion between doors when they are placed adjacent to each other for shipment and storage, the raised portion 317 connects to the protective cover 310. The constant spacing between doors prevents “A” framing when palletizing single or double doors. The raised portion 317 can be on the order of ½ inch to 1½ inches high, as deemed appropriate for the desired spacing between doors.

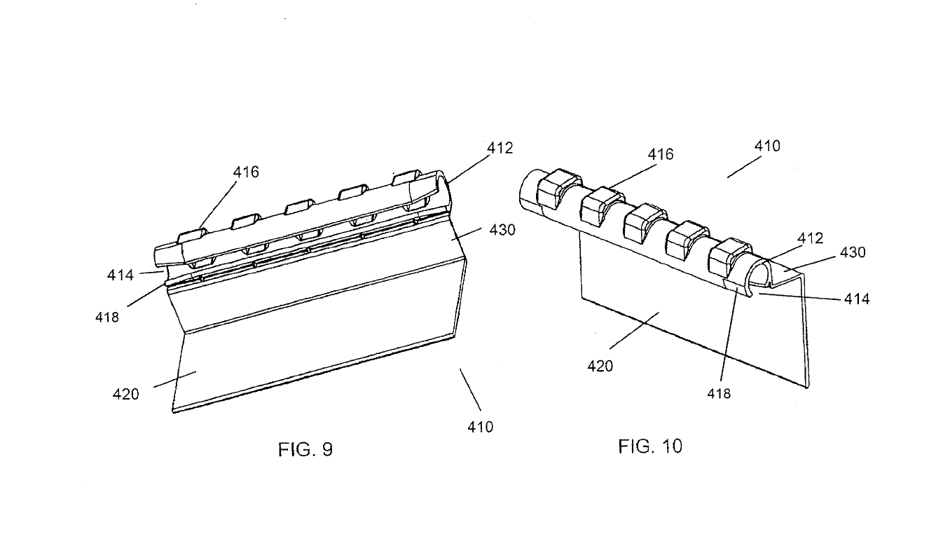

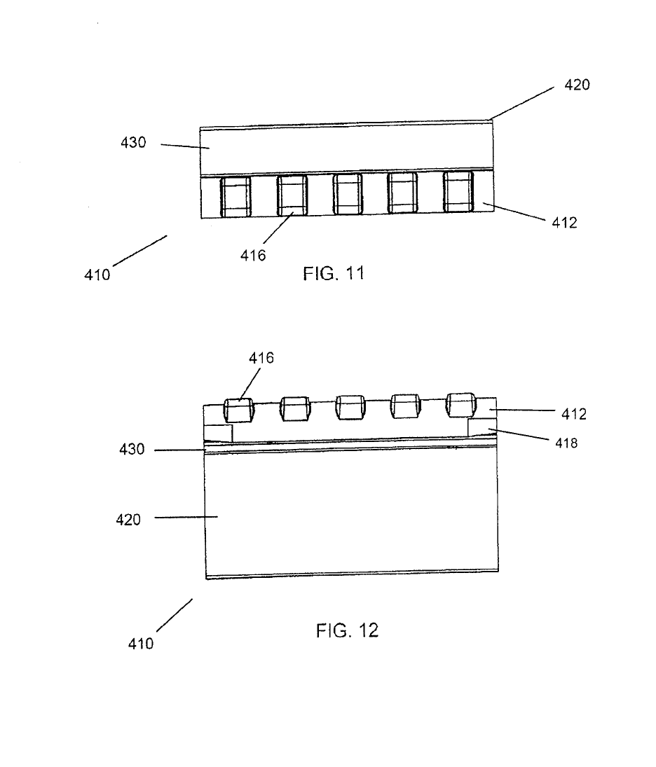

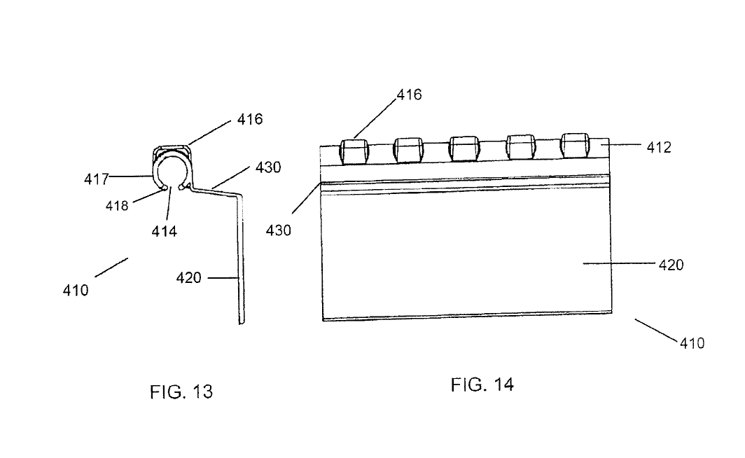

FIGS. 9 through 14 are views of version of a version of the door protector 410 that has a ledge portion 430 that separates the location of the cylindrical portion 412 from the extension 420, thus positioning the protective cover 410 with respect to the door jamb. Features similar to those found in the first version of the protector 110 are given similar numerals having the same last two digits.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A protective cover for application to a door hinge, said hinge of the type having a generally longitudinal cylindrical bore and two extensions for attachment to a door and door jamb, respectively, said protective cover comprising:
a cylindrical portion having an inner diameter dimensioned to closely fit the outer surface of said hinge bore, said cylindrical portion having a longitudinal opening at least as long as said hinge bore and narrower in width than the width of said hinge bore;
wherein said protective cover is produced of molded flexible material; and
wherein said cylindrical portion can be flexibly manipulated to expand the size of said longitudinal opening to fit over said bore for removable attachment of said protective cover to said hinge.

2. The protective cover of claim 1 wherein said molded flexible material is plastic.

3. The protective cover of claim 2 wherein plastic is HDPE.

4. The protective cover of claim 2 wherein plastic is LDPE.

5. The protective cover of claim 1 further comprising a flap portion extending from said cylindrical portion, wherein when said cylindrical portion is attached to said hinge, said extension lays over the jamb of a pre-hung assembly.

6. The protective cover of claim 5 wherein said flap portion is substantially flat.

7. The protective cover of claim 5 wherein said flap portion is sized to overlay screw tips associated with the attachment of said hinge to said jamb.

8. The protective cover of claim 5 wherein said flap portion is integrally formed with said cover portion.

9. The protective cover of claim 5 wherein said flap portion is sized to allow penetration of staples to further secure the protective cover to said jamb.

10. The protective cover of claim 1 further comprising a raised portion connected to said protective cover for providing spacing between doors.

11. The protective cover of claim 1 further comprising a ledge portion for position said protective cover with respect to said jamb.

12. The protective cover of claim 1 further comprising an expanded notched region at the respective ends of said longitudinal opening.

13. The protective cover of claim 1 wherein said cylindrical portion is at least about 2 inches in length.

14. The protective cover of claim 13 wherein said cylindrical portion is at least about 3 inches in length.

15. The protective cover of claim 14 wherein said cylindrical portion is at least about 4 inches in length.
